(19) United States
(12) Patent Application Publication
(10) Pub. No.: US 2025/0387851 A1
(43) Pub. Date: Dec. 25, 2025

(54) INSPECTION METHOD AND INSPECTION DEVICE FOR WORKPIECE IN LASER MACHINING

(71) Applicant: Panasonic Intellectual Property Management Co., Ltd., Osaka (JP)

(72) Inventors: KAZUKI FUJIWARA, Osaka (JP); KOJI FUNAMI, Kyoto (JP); IZURU NAKAI, Osaka (JP); TATSURO SHIRAISHI, Osaka (JP)

(21) Appl. No.: 19/313,842

(22) Filed: Aug. 28, 2025

Related U.S. Application Data
(63) Continuation of application No. PCT/JP2024/006388, filed on Feb. 21, 2024.

(30) Foreign Application Priority Data
Mar. 27, 2023 (JP) 2023-049726

(51) Int. Cl. B23K 26/04; B23K 26/03

(52) U.S. Cl. CPC B23K 26/04; B23K 26/032

(57) ABSTRACT

An inspection method includes steps of: acquiring a signal generated by detecting, with an optical sensor, at least one of components of heat radiation, visible light, and reflected light generated by irradiation to a workpiece with a laser beam, and indicating a change in the component in a period corresponding to a machining time for each workpiece;
calculating a feature amount indicating a feature of the signal in a predetermined period of the period;
determining surface roughness of the workpiece by inputting the calculated feature amount to a determination model that determines surface roughness indicating a surface property of a surface of the workpiece irradiated with the laser beam; and
outputting a predicted value of the calculated surface roughness as an inspection result.

### TECHNICAL FIELD

The present disclosure relates to inspection method and inspection device for workpiece in laser machining.

### BACKGROUND ART

PLT 1 discloses a method that is applied to laser welding in which a work is irradiated with a pulsed laser beam to perform welding, and determines a welding state such as good or bad welding in the work. In the method of PLT 1, intensities of plasma light and reflected light emitted from a work at the time of laser welding are detected, and a feature value for each pulse is extracted for each pulse of the laser beam based on a detection light intensity in an extraction section set in advance in one cycle corresponding to one pulse of the laser beam. As the feature value for each pulse, an average value of the detection light intensity, a change amount resulting from difference processing, and an amplitude resulting from difference processing are calculated, for example. In the method of PTL 1, the lowest value or the highest value of the feature value for each pulse is compared with a predetermined threshold value, and whether a welding defect has occurred is determined as a welding state for each work.

### CITATION LIST

### Patent Literature

PTL 1: Unexamined Japanese Patent Publication No. 2000-153379

### SUMMARY OF THE INVENTION

In laser machining such as welding, a state of a workpiece (work) may affect machining accuracy, quality after machining, and the like. For example, in laser welding, when the surface roughness is different as the state of the workpiece, the welding quality may be affected, and it takes time to grasp the details including causes other than the surface roughness such as cross-section observation of the machining portion in order to investigate the cause of such an influence. In addition, in a situation where machining is repeated in equipment or the like with a large number of productions, when the surface roughness is measured for each machining, loss of production time increases, and a highly accurate measuring instrument is required for measuring the surface roughness. Therefore, it is not realistic to inspect the workpiece by measuring the surface roughness before each machining with the production equipment or the like.

The present disclosure provides an inspection device and an inspection method capable of easily inspecting surface roughness of a workpiece in laser machining.

According to one aspect of the present disclosure, a method for inspecting a workpiece in laser machining is provided.

An inspection method includes steps of:
acquiring a signal generated by detecting, with an optical sensor, at least one of components of heat radiation, visible light, and reflected light generated by irradiation to a workpiece with a laser beam, and indicating a change in the component in a time section corresponding to a machining time for each workpiece;
calculating a feature amount indicating a feature of the signal in a predetermined section of the time section;
determining surface roughness of the workpiece by inputting the calculated feature amount to a determination model that determines surface roughness indicating a surface property of a surface of the workpiece irradiated with the laser beam; and
outputting a predicted value of the calculated surface roughness as an inspection result.

The determination model is constructed based on training data including a feature amount calculated from a signal of a component detected by performing laser machining under each condition in a plurality of conditions in which the surface roughness is varied and the surface roughness of each condition in association with each other.

According to one aspect of the present disclosure, an inspection device for a workpiece in laser machining is provided. The inspection device includes an arithmetic circuit and a communication circuit that receives a signal generated by detecting at least one of components of heat radiation, visible light, and reflected light generated by irradiation to a workpiece with a laser beam by an optical sensor. The signal is a signal indicating a change in a component in a time section corresponding to the machining time for each workpiece. The arithmetic circuit acquires a signal by the communication circuit, calculates a feature amount indicating a feature of the signal in a predetermined section of the time section, inputs the calculated feature amount to a determination model that determines surface roughness indicating a surface property of a surface of a workpiece irradiated with the laser beam, determines the surface roughness of the workpiece, and outputs a predicted value of the calculated surface roughness as an inspection result. The determination model is constructed based on training data including a feature amount calculated from a signal of a component detected by performing laser machining under each condition in a plurality of conditions in which the surface roughness is varied and the surface roughness of each condition in association with each other.

According to the inspection method and the inspection device of the present disclosure, it is possible to easily inspect the surface roughness of the workpiece in the laser machining.

### BRIEF DESCRIPTION OF THE DRAWINGS

FIG. 1 is a diagram illustrating an outline of an inspection system according to a first exemplary embodiment of the present disclosure.

FIG. 2 is a diagram illustrating a configuration of a laser machining device in the inspection system.

FIG. 3 is a diagram illustrating a configuration of a spectrometer in the inspection system.

FIG. 4 is a block diagram illustrating a configuration of an inspection device in the inspection system.

FIG. 5 is a flowchart illustrating inspection processing in the inspection device.

FIG. 6 is a diagram for explaining a signal acquired in the inspection device.

FIG. 7 is a diagram for explaining a relationship between a feature amount calculated by the inspection device and surface roughness.

FIG. 8 is a flowchart illustrating training processing of a determination model used in the inspection processing.

FIG. 9 is a diagram for explaining training data for the determination model.

FIG. 10 is a flowchart illustrating generation processing of the training data.

### DESCRIPTION OF EMBODIMENT

Hereinafter, exemplary embodiments will be described in detail with reference to the drawings as appropriate. Note that unnecessarily detailed description is omitted in some cases. For example, a detailed description of an already well-known matter and a duplicated description of substantially the same configuration will be omitted in some cases. These are to avoid an unnecessarily redundant description and to facilitate understanding of a person skilled in the art. Note that, the attached drawings and the following description are presented by the inventors of the present disclosure so that those skilled in the art can fully understand the present disclosure, and are not intended to limit the subject matter as described in the claims.

### First Exemplary Embodiment

In a first exemplary embodiment, as an example of using an inspection method and an inspection device according to the present disclosure, an inspection system that detects a component of light generated in laser machining for lap-welding, acquires a signal based on the detected component, and inspects surface roughness of a workpiece will be described.

### 1. Configuration

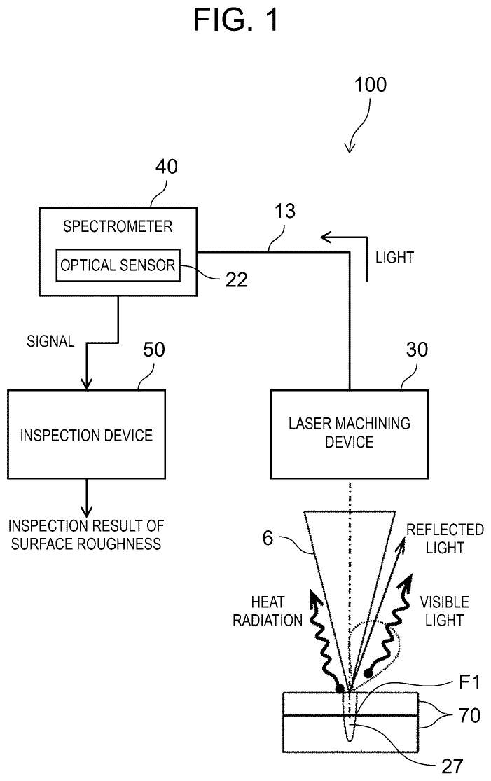

An inspection system according to the first exemplary embodiment will be described with reference to FIG. 1. FIG. 1 is a diagram illustrating an outline of inspection system 100 according to the present exemplary embodiment.

### 1-1. Outline of System

Inspection system 100 includes laser machining device 30 that performs laser machining for lap-welding, spectrometer 40 for detecting a component of light, and inspection device 50. Workpiece 70 to be subjected to laser machining is made of metal, for example. When the workpiece 70 is irradiated with laser beam 6, heat radiation in a near-infrared region due to an increase in temperature, and emission or plasma emission (hereinafter, referred to as “visible light”) unique to metal, which is mainly a visible light component, are generated. In addition, a part of laser beam 6 that does not contribute to machining is reflected to be a return light. As described above, when workpiece 70 is irradiated with laser beam 6 from laser machining device 30, heat radiation, visible light, and reflected light are generated in, for example, melted portion 27 formed by melting metal on workpiece 70.

The generated light is condensed in laser machining device 30 and is transmitted to spectrometer 40 through optical fiber 13 connecting laser machining device 30 to spectrometer 40. The light transmitted to spectrometer 40 is dispersed into components of the heat radiation, the visible light, and the reflected light, and the dispersed components are detected by optical sensor 22 of spectrometer 40 and are converted into signals. Upon receiving the signal from spectrometer 40, inspection device 50 determines the surface roughness of workpiece 70 based on the received signal, and outputs the determined surface roughness as an inspection result of workpiece 70.

### 1-2. Configuration of Laser Machining Device

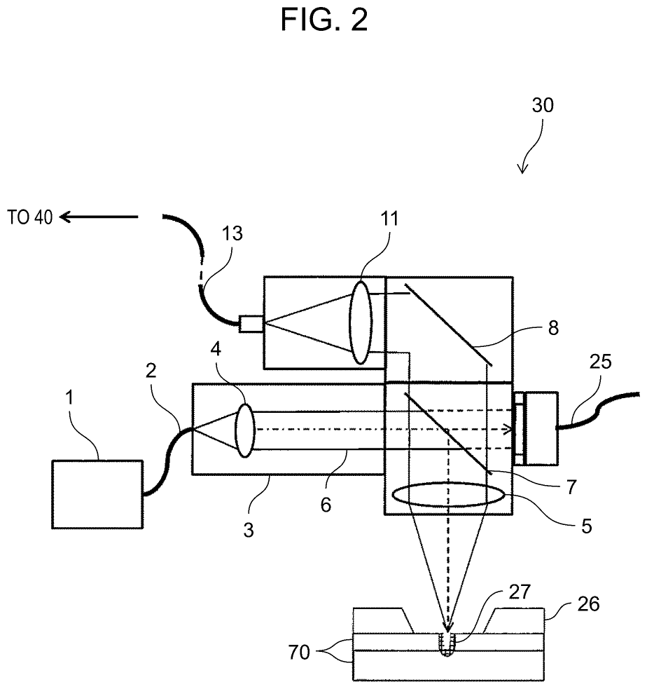

FIG. 2 is a diagram illustrating a configuration of laser machining device 30 of the present exemplary embodiment. Laser machining device 30 includes laser oscillator 1, laser transmission fiber 2, lens barrel 3, collimating lens 4, condenser lenses 5, 11, first mirror 7, and second mirror 8.

Laser oscillator 1 supplies light for generating pulsed laser beam 6 having a wavelength of, for example, about 1070 nanometers (nm). The light supplied from laser oscillator 1 is amplified while being transmitted through laser transmission fiber 2, passes through collimating lens 4 for obtaining a parallel beam, forms into laser beam 6, and travels straight in lens barrel 3. Lens barrel 3 constitutes a machining head of laser machining device 30.

Laser beam 6 is reflected by first mirror 7 except for a portion passing through first mirror 7, and reflected laser beam 6 is condensed by condenser lens 5 and irradiated on workpiece 70 fixed on a scanning table by hold jig 26, for example. As a result, laser machining for lap-welding of workpieces 70 is performed. Note that, the wavelength of laser beam 6 is not particularly limited to 1070 nm. A wavelength having a high absorption rate in a material is preferably used.

When laser beam 6 is irradiated, heat radiation from workpiece 70, visible light of plasma emission, and reflected light of laser beam 6 are generated at melted portion 27. These light components are transmitted through first mirror 7, are reflected by second mirror 8, are condensed by condenser lens 11, and are then transmitted to spectrometer 40 through optical fiber 13. Laser machining device 30 of the present exemplary embodiment further includes optical sensor 25, and optical sensor 25 detects light partially transmitted through second mirror 8. Optical sensor 25 generates an electric signal corresponding to the intensity of the detected light. The generated electric signal may be transmitted to controller 24 of spectrometer 40 to be described later via, for example, a transmission cable or the like connected to laser machining device 30 and spectrometer 40.

As a detection position of the transmitted light by optical sensor 25, for example, detection is performed at a position before laser beam 6 reaches workpiece 70, whereby a correlation between the signal intensity of the detection result and the output of laser oscillator 1 can be accurately obtained, but the detection position is not particularly limited thereto.

### 1-3. Configuration of Spectrometer

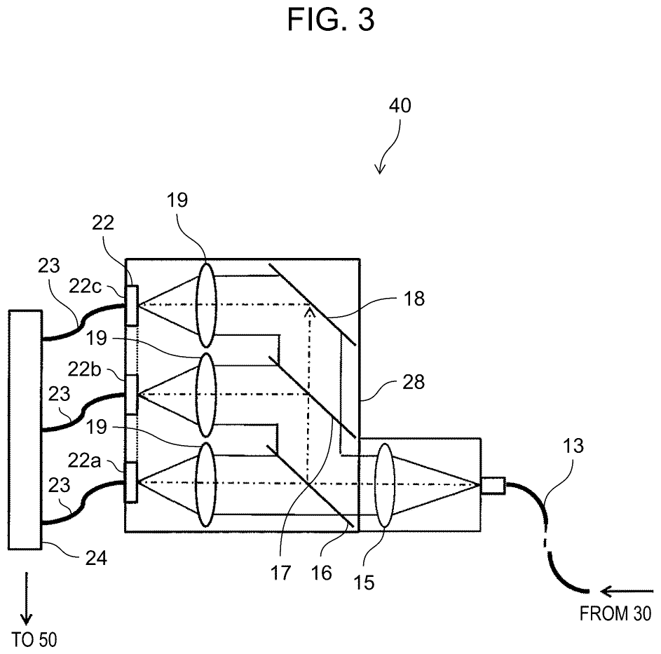

FIG. 3 is a diagram illustrating a configuration of spectrometer 40 of the present exemplary embodiment. Spectrometer 40 includes, in housing 28, collimating lens 15, third mirror 16, fourth mirror 17, fifth mirror 18, condenser lenses 19, 20, 21, optical sensor 22, transmission cables 23, and controller 24. Housing 28 prevents other light rays from entering from outside spectrometer 40 and leakage of light from inside spectrometer 40.

Collimating lens 15 changes the light transmitted from laser machining device 30 through optical fiber 13 into parallel light again. For example, third mirror 16 transmits visible light having a wavelength of 400 nm to 700 nm, and reflects other components. Fourth mirror 17 reflects the reflected light of laser beam 6 having a wavelength of about 1070 nm, for example, and transmits other components. Fifth mirror 18 reflects heat radiation having a wavelength of 1300 nm to 1550 nm, for example.

The light having passed through collimating lens 15 is dispersed by third mirror 16, fourth mirror 17, and fifth mirror 18 into components of visible light, reflected light, and heat radiation, and the dispersed components are condensed by condenser lenses 19 to 21. Note that, any selected bandpass filter may be disposed in each of optical paths respectively coming from third mirror 16, fourth mirror 17, and fifth mirror 18 to select a certain wavelength of the light that passes through the bandpass filter.

Optical sensor 22 includes, for example, optical sensors 22a, 22b, 22c each having high sensitivity for a wavelength that differs among optical sensors 22a, 22b, 22c. Optical sensors 22a, 22b, 22c detect components of the visible light, the reflected light, and the heat radiation condensed by condenser lenses 19 to 21, respectively, and each generate an electric signal corresponding to the intensity of the detected light. Note that, optical sensor 22 may be a single optical sensor capable of detecting the intensity of each wavelength.

The electrical signal generated by optical sensor 22 is transmitted to controller 24 via transmission cables 23. Controller 24 is a hardware controller, and integrally controls all the operations of spectrometer 40. Controller 24 includes a CPU and a communication circuit, and transmits the electric signal received from optical sensor 22 to inspection device 50. Controller 24 includes, for example, an A/D converter, and converts an analog electric signal into a digital signal (also simply referred to as “signal”). The sampling period at the time of conversion into the digital signal is preferably, for example, less than or equal to 1/100 of the time for performing the output control of laser beam 6 from the viewpoint of securing the sufficient number of samples for capturing the feature of the machining process and the tendency of the local value of the physical quantity.

### 1-4. Configuration of Inspection Device

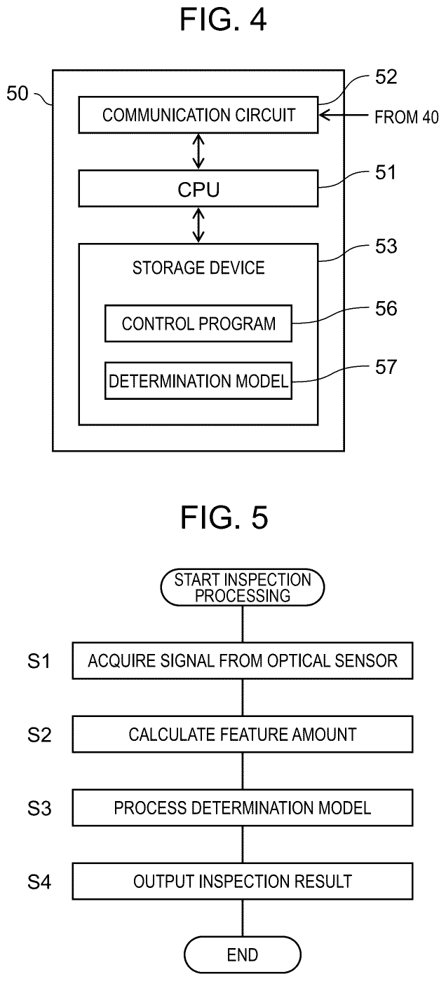

FIG. 4 is a block diagram illustrating a configuration of inspection device 50 of the present exemplary embodiment. Inspection device 50 is, for example, an information processing device such as a computer. Inspection device 50 includes CPU 51 that performs arithmetic processing, communication circuit 52 for communication with other devices, and storage device 53 that stores data and a computer program.

CPU 51 is an example of an arithmetic circuit of inspection device 50 of the present exemplary embodiment. CPU 51 implements a predetermined function including construction of determination model 57 and inspection of workpiece 70 by constructed determination model 57 by execution of control program 56 stored in storage device 53. For example, when CPU 51 executes control program 56, a function as inspection device 50 of the present exemplary embodiment is implemented. In the present exemplary embodiment, the arithmetic circuit of inspection device 50 configured as CPU 51 may be implemented by various processors such as an MPU or a GPU, or may be configured by one or more processors.

Communication circuit 52 is a communication circuit that performs communication in accordance with a standard such as IEEE 802.11, 4G, and 5G. Communication circuit 52 may perform wired communication in accordance with a standard such as Ethernet (registered trademark). Communication circuit 52 is connectable to a communication network such as the Internet. In addition, inspection device 50 may directly communicate with another device via communication circuit 52, or may communicate via an access point. Note that, communication circuit 52 may be configured to be able to communicate with another device without a communication network. For example, communication circuit 52 may include a connection terminal such as a USB (registered trademark) terminal and an HDMI (registered trademark) terminal.

Storage device 53 is a storage medium that stores computer programs and data necessary for implementing the functions of inspection system 100. Storage device 53 stores control program 56 executed by CPU 51 and various data, and stores determination model 57 after determination model 57 is constructed. Determination model 57 is constructed by machine learning based on training data including, for a plurality of machining conditions having different surface roughness of workpiece 70, a feature amount indicating a feature of a signal detected at the time of laser machining under each condition and surface roughness obtained by measurement under each condition in association with each other.

In the present exemplary embodiment, determination model 57 is a regression model realized by, for example, linear regression, Lasso regression, ridge regression, decision tree, random forest, gradient boosting, support vector regression, Gaussian process regression, k-nearest neighbor algorithm, neural network, or the like. Determination model 57 of the present exemplary embodiment outputs a numerical value indicating displacement of workpiece 70 in the vertical direction from the reference surface as the determination result of the surface roughness. Details of the construction of determination model 57 will be described later.

Storage device 53 is configured as, for example, a magnetic storage device such as a hard disk drive (HDD), an optical storage device such as an optical disk drive, or a semiconductor storage device such as a solid state drive (SSD). Storage device 53 may include a temporary storage element configured by a RAM such as a DRAM or an SRAM, or may function as an internal memory of CPU 51.

### 2. Operation

In inspection system 100 having the above configuration, for example, as illustrated in FIG. 1, spectrometer 40 detects, by optical sensor 22, the components of the heat radiation, the visible light, and the reflected light generated at melted portion 27 by irradiation of laser beam 6. Spectrometer 40 transmits a signal corresponding to the intensity of each detected component to inspection device 50. The operation of inspection device 50 of present system 100 will be described below.

### 2-1. Inspection Processing

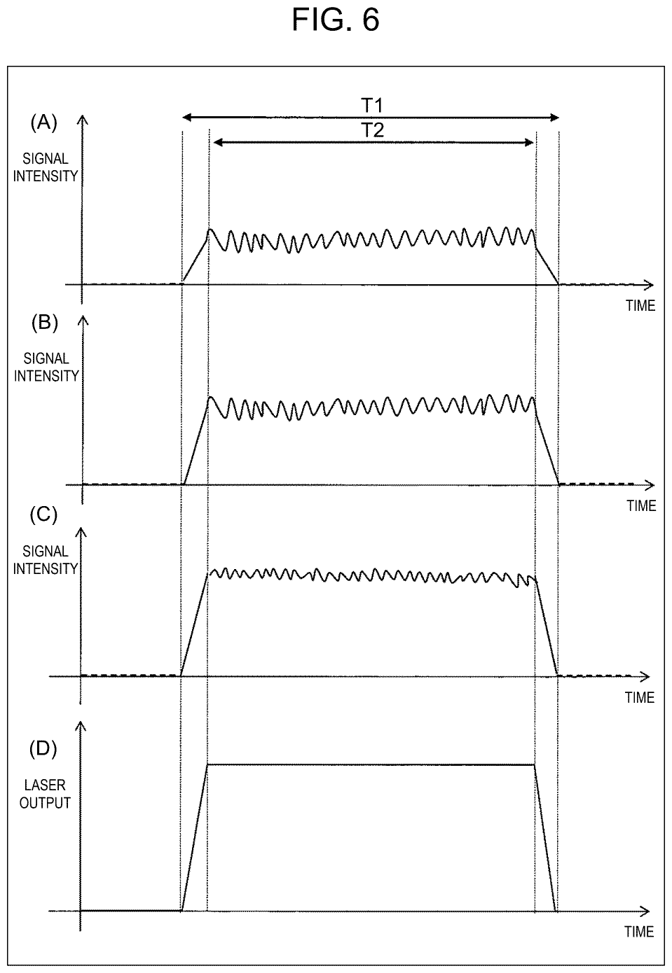

Hereinafter, inspection processing of inspecting the surface roughness at the time of machining of workpiece 70 by laser machining device 30 in inspection device 50 will be described with reference to FIGS. 5 and 6.

FIG. 5 is a flowchart illustrating determination processing in inspection device 50 of the present exemplary embodiment. Each processing illustrated in the flowchart is executed by, for example, CPU 51 of inspection device 50. The flowchart starts by, for example, a user of inspection system 100 or the like inputting a predetermined operation for starting the inspection processing from an input device connected via communication circuit 52.

First, CPU 51 acquires, by communication circuit 52, signals corresponding to the components of the heat radiation, the visible light, and the reflected light detected by optical sensor 22 of spectrometer 40 (S1).

FIG. 6 is a diagram for explaining a signal acquired by inspection device 50. Parts (A), (B), and (C) of FIG. 6 illustrate signal waveforms respectively corresponding to intensities of heat radiation, visible light, and reflected light. Part (D) of FIG. 6 illustrates an output of laser beam 6 irradiated to workpiece 70. Signals in parts (A) to (C) of FIG. 6 respectively correspond to heat radiation, visible light, and reflected light generated by the laser output. In parts (A) to (D) of FIG. 6, a horizontal axis represents time, and a vertical axis represents signal intensity (in parts (A) to (C) of FIG. 6) or laser output (in part (D) of FIG. 6). In addition, in parts (A) to (D) of FIG. 6, time section T1 indicates a time section corresponding to one pulse of laser beam 6, and time section T2 indicates a time section of the peak output excluding the rise-up and fall-down of the laser output.

In laser machining device 30 of the present exemplary embodiment, welding is performed for each workpiece 70 in time section T1 corresponding to one pulse of laser beam 6. In step S1 in FIG. 5, as illustrated in parts (A) to (C) of FIG. 6, CPU 51 obtains a signal indicating a change in each component of heat radiation, visible light, and reflected light in time section T1 corresponding to the welding time for each workpiece 70.

Next, CPU 51 calculates a feature amount to be input to determination model 57 from the obtained signal (S2). The feature amount is calculated from, for example, a signal waveform indicating a temporal change in signal intensity of each component, and includes an average intensity indicating an average value of the signal intensity in time section T2 and an integrated value of the signal intensity in time section T2.

CPU 51 inputs the feature amount calculated from the signal of each component detected at the time of machining of workpiece 70 to determination model 57, and performs processing (S3) of the determination model that determines the surface roughness of workpiece 70. In the processing (S3) of the determination model of the present exemplary embodiment, CPU 51 calculates a predicted value of a numerical value indicating the surface roughness of the upper surface of workpiece 70 irradiated with laser beam 6. The relationship between the feature amount and the surface roughness will be described later in detail.

CPU 51 outputs the numerical value of the surface roughness of the upper surface of workpiece 70 calculated by the processing of determination model (S3) as the inspection result of workpiece 70 (S4). For example, CPU 51 may write the inspection result to storage device 53, or may transmit the inspection result to the outside of inspection device 50 through communication circuit 52. The inspection result can be received and displayed by, for example, an information processing device or a display equipment outside inspection device 50. In addition, inspection device 50 may include a display device (for example, a display) capable of communicating with CPU 51, and causes the display device to display the inspection result.

Then, CPU 51 ends the flowchart in FIG. 5. The flowchart in FIG. 5 is repetitively executed, for example, whenever welding machining is performed for each workpiece 70.

According to the above inspection processing, inspection device 50 of the present exemplary embodiment acquires the signal generated by optical sensor 22 of spectrometer 40 (S1), calculates the feature amount from the signal (S2), and performs the processing of determination model 57 for inspecting the surface roughness of workpiece 70 based on the feature amount (S3). In this manner, it is possible to inspect the surface roughness of the upper surface of workpiece 70, which is the irradiation surface of laser beam 6, from the signal of the light generated at the time of machining in the laser machining without directly measuring the surface roughness. As a result, the surface roughness can be easily inspected, and for example, it is possible to grasp the influence on the machining state due to the variation in the surface roughness for each machining.

In addition, when inspection device 50 as described above is used at a manufacturing site of a product by laser machining, for example, by providing a determination criterion for whether a welding defect occurs with respect to surface roughness so that a welding defect does not flow out to a subsequent process, it is possible to discharge the welding defect according to an inspection result.

### 2-2. Feature Amount and Surface Roughness

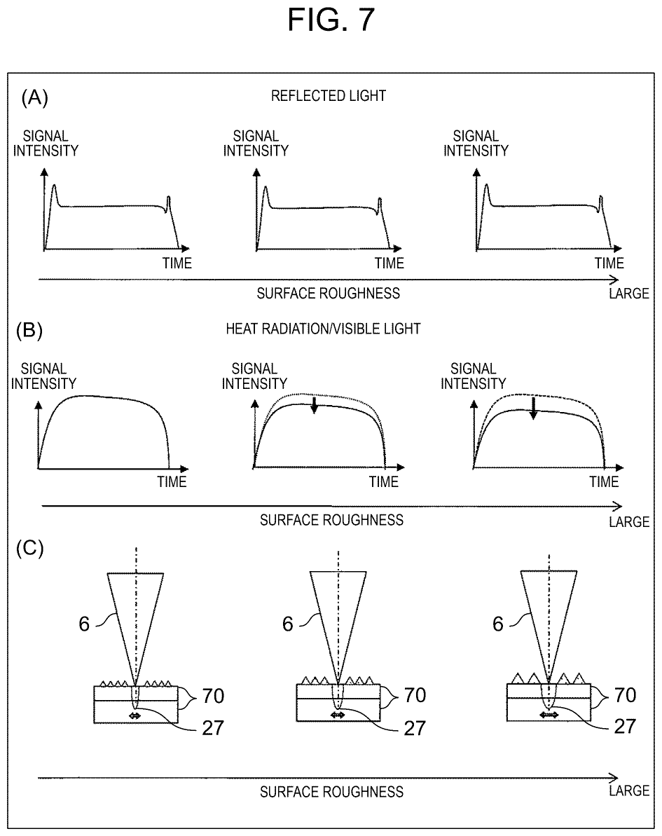

With reference to FIG. 7, knowledge obtained by the inventors of the technology in the present disclosure will be described regarding the relationship between the surface roughness and the feature amount calculated based on the signal intensity of light detected at the time of laser machining in the inspection processing as described above.

FIG. 7 is a diagram for explaining a relationship between surface roughness and a feature amount calculated in inspection device 50. Part (A) of FIG. 7 illustrates a temporal change in signal intensity of reflected light detected for each machining in each case where the surface roughness of workpiece 70 is different. Part (B) of FIG. 7 illustrates a temporal change in signal intensity of heat radiation or visible light detected in each case similar to part (A) of FIG. 7. Part (C) of FIG. 7 schematically illustrates a relationship between the surface roughness of workpiece 70 and melted portion 27 formed at the time of machining.

When workpiece 70 has different surface roughness, the surface reflection of laser beam 6 on workpiece 70 and/or the flow of hot water in melted portion 27 changes to affect the shape of melted portion 27. For example, as illustrated in part (C) of FIG. 7, when the surface roughness changes, the shape of melted portion 27 changes, and the detected signal intensity changes as illustrated in parts (A), (B) of FIG. 7 according to the change in the light amount due to the light emission and the scattered light in melted portion 27.

When the surface roughness is small, in melted portion 27, for example, the melted metal by laser beam 6 is less likely to spread in the melting width direction, that is, the direction orthogonal to the scanning direction, and an input heating value can be concentrated while the shape is maintained. Therefore, it is assumed that the melting temperature increases, the surface temperature of melted portion 27 increases, and the amount of light emission and the corresponding signal intensity are relatively large. On the other hand, when the surface roughness is large, the melted metal in melted portion 27 likely to spread in the melting width direction, and the heating value may be dispersed. Therefore, it is assumed that the surface temperature of melted portion 27 decreases, and the amount of light emission and the corresponding signal intensity are relatively small.

In inspection device 50 of the present exemplary embodiment, determination model 57 that determines the surface roughness of workpiece 70 using the feature amount according to the signal intensity from the signal corresponding to at least one component of the heat radiation, the visible light, and the reflected light at the time of machining is constructed by the training processing to be described later based on the above knowledge. The feature amount input to determination model 57 described above will be described below.

For example, CPU 51 of inspection device 50 calculates the average intensity of each signal as the feature amount in time section T2 corresponding to the period of the peak output for each machining by laser oscillator 1 of laser machining device 30. Time section T2 can be determined, for example, from the output waveform of laser oscillator 1.

In addition, as described above, when the surface roughness of workpiece 70 increases or decreases, not only the shape of melted portion 27 is affected, but also the temperature of the portion of workpiece 70 irradiated with laser beam 6 changes, and the light amounts of reflected light, heat radiation, and visible light from melted portion 27 change. In inspection device 50 of the present exemplary embodiment, for example, CPU 51 calculates an integrated value of signal intensity in time section T2 of the peak output of laser beam 6 in addition to the average intensity as the feature amount corresponding to the change in the light amount.

### 2-3. Determination Model Training Processing

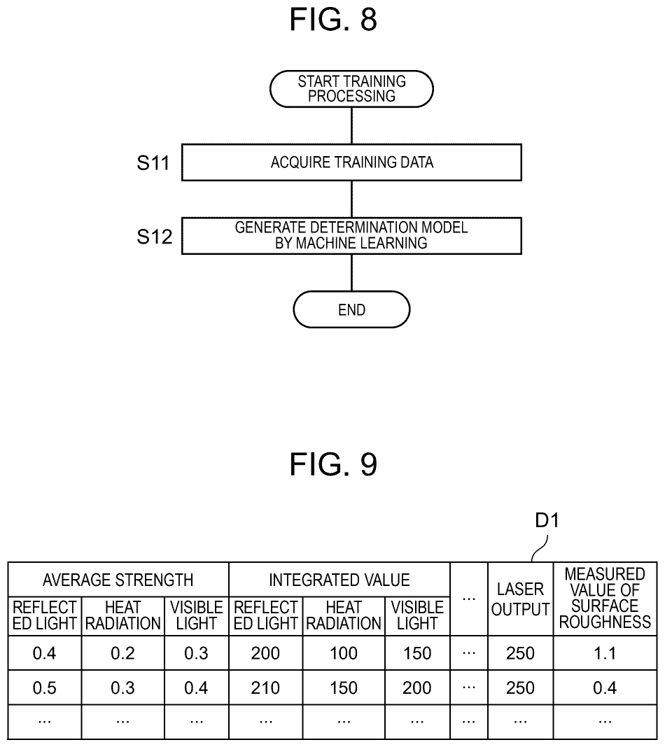

Training processing for constructing determination model 57 will be described below with reference to FIGS. 8 and 9.

FIG. 8 is a flowchart illustrating training processing of determination model 57 used in inspection processing. Each processing in the flowchart is executed by, for example, CPU 51 of inspection device 50.

First, CPU 51 acquires, for example, training data previously stored in storage device 53 (S11).

FIG. 9 is a diagram for explaining training data D1 of determination model 57. Training data D1 is data in which a feature amount for each machining of workpiece 70 is associated with, for example, an actual measurement value of the surface roughness of workpiece 70 measured before the machining. Training data D1 is constructed by performing laser machining by laser machining device 30 under each condition in a plurality of conditions in which machining conditions at the time of welding are changed, for example, and acquiring data such as signals detected via spectrometer 40 and an actual measurement value of surface roughness.

In training data D1 in FIG. 9, in addition to the feature amounts of the average intensity and the integrated value calculated based on a signal of each component of heat radiation, visible light, and reflected light, the output of laser oscillator 1 is also recorded in association with each condition. As an actual measurement value of the surface roughness, for example, arithmetic average height Ra or maximum height Rz of line roughness indicating two-dimensional surface property, or arithmetic average height Sa or maximum height Sz of surface roughness indicating three-dimensional surface property is calculated from a measurement result of the upper surface of workpiece 70 by a shape measurement instrument or the like. The surface roughness may include a plurality of such indicators. In addition, measurement and laser machining may be performed a plurality of times under each condition, and an average value or the like of the acquired data of the plurality of times may be set as an actual measurement value and a feature amount of the condition.

As the surface roughness, for example, when the surface of workpiece 70 is polished with sandpaper or the like having a different count, the displacement in the height direction from a predetermined reference surface is changed. In addition, a plurality of surface roughness conditions may be provided for each count of such sandpaper, but the conditions are not limited thereto. Furthermore, in the laser machining of the lap-welding, from the viewpoint of managing associating whether or not workpiece 70 after machining has a desired joint strength with the surface roughness of workpiece 70, a measurement result of the joint strength may be acquired after machining under each condition. The generation of training data D1 will be described later in detail.

Returning to FIG. 8, CPU 51 performs machine learning using acquired training data D1, and generates determination model 57 so as to calculate the corresponding surface roughness from the feature amount (S12). In step S12, CPU 51 performs machine learning of determination model 57 so as to minimize an error between the surface roughness determined by determination model 57 from the feature amount of each condition in training data D1 and the surface roughness in training data D1 of each condition.

According to the above training processing, determination model 57 can be generated as a learned model that calculates the predicted value of the surface roughness from the feature amount calculated from the signal of each component of the heat radiation, the visible light, and the reflected light detected in the laser machining.

Note that, the training processing of determination model 57 may be performed in an information processing device other than inspection device 50. Inspection device 50 may acquire an already constructed determination model by communication circuit 52 via, for example, a communication network. In addition, training data D1 is not limited to the example of FIG. 9, and may include, for example, feature amounts calculated for some components of heat radiation, visible light, and reflected light, or may include only one of average intensity and an integrated value.

### 2-4. Generation Processing of Training Data

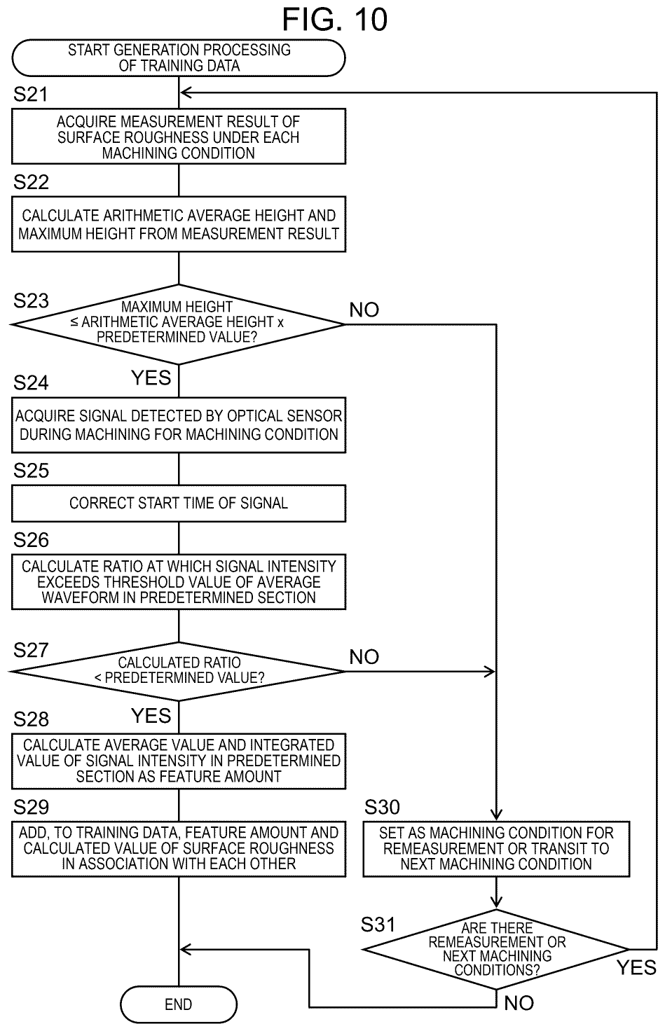

Inspection device 50 of the present exemplary embodiment performs processing of generating training data D1 of determination model 57 before the generation processing of determination model 57 described above, for example. The processing includes, for example, preprocessing for accurately generating determination model 57 based on training data D1 obtained in the processing. Such generation processing of training data D1 will be described with reference to FIG. 10.

FIG. 10 is a flowchart illustrating generation processing of training data D1. For example, the processing of the flowchart is started in a state in which a measurement result of the surface roughness measured before machining and a signal of each component such as reflected light detected at the time of laser machining are obtained under a plurality of conditions in which the surface roughness of workpiece 70 similar to the inspection target is changed. The measurement result of the surface roughness and the signal under each machining condition are stored in, for example, storage device 53 of inspection device 50. A plurality of machining conditions are set in advance, for example, and stored in storage device 53. In addition, each processing in the flowchart is executed by, for example, CPU 51 of inspection device 50.

Furthermore, in the present exemplary embodiment, from the viewpoint of generating training data D1 capable of constructing determination model 57 with higher accuracy, predetermined preprocessing is executed for the measurement result of the surface roughness and the detected signal before generation of training data D1 (S23, S25 to S27, etc.). For example, in some cases, the signal at the time of machining fluctuates due to not only a change in surface roughness of workpiece 70 but also foreign matters such as dirt adhered to the surface. When a large number of signals that change due to a factor other than the surface roughness are included in training data D1, there is concern that determination model 57 trained by training data D1 has difficulty in learning the correlation between the feature amount of the signal and the surface roughness. The preprocessing of the present exemplary embodiment includes processing for preventing such a signal from being included in training data D1.

In the processing of FIG. 10, first, CPU 51 acquires a measurement result of surface roughness measured by a shape measurement instrument or the like under one machining condition from storage device 53, for example (S21). The accuracy of the measurement instrument is preferably measurable up to the nanometer (nm) order, but is not particularly limited as long as the accuracy is in the micrometer (μm) order. The region to be measured on the surface of workpiece 70 may be determined according to the welding shape, and for example, the region is determined according to the range irradiated with laser beam 6. Workpiece 70 having different surface roughness may be formed, for example, by changing the count of sandpaper for polishing the surface of workpiece 70 before machining every 100.

In addition to the measurement of the surface roughness, the joint strength of welded workpiece 70 may be measured. For example, measurement of tensile strength by a tensile tester, torque strength, or the like can be measured, but the measurement method is not particularly limited. In this case, from the measurement result of the joint strength, for example, whether or not a desired joint strength is secured for each condition can be managed in association with the training data D1.

Next, CPU 51 calculates the arithmetic average height and the maximum height from the measurement result of the surface roughness (S22). For example, each parameter of arithmetic average height Ra and maximum height Rz of the line roughness, or arithmetic average height Sa and maximum height Sz of the surface roughness is calculated according to the measurement method. Surface roughness parameters Sa, Sz are parameters obtained by three-dimensionally expanding line roughness parameters Ra, Rz calculated from the contour curve according to the measurement result. For example, the arithmetic average heights Ra, Sa are obtained by the following calculations, respectively.

$$R a = \frac{1}{b} {\int }_{0}^{b} \vert Z ( x ) \vert dx \qquad [ Math . 1 ]$$

$$Sa = \frac{1}{A} \int {\int }_{A} \vert Z ( x , y ) \vert dxdy \qquad [ Math . 2 ]$$

Here, b represents the reference length of the contour curve in the measurement of the line roughness, A represents the reference region in the measurement of the surface roughness, and Z represents the coordinate value in the height direction according to the measurement result.

Hereinafter, an example in which arithmetic average height Sa and maximum height Sz of the surface roughness are calculated in step S22 will be described. In addition, the arithmetic average height is simply referred to as “average height” in some cases. Maximum height Sz is calculated by the sum of the maximum mountain height and the maximum valley depth in reference region A.

CPU 51 determines whether calculated maximum height Sz is less than or equal to a value obtained by multiplying average height Sa by a predetermined value, that is, whether maximum height Sz and average height Sa have a relationship of “Sz≤Sa x predetermined value” (S23). When the surface roughness is measured, if a foreign matter or the like adheres to the measurement region on the surface of workpiece 70, the numerical value of the measurement result may fluctuate with respect to the actual surface roughness. The type of the foreign matter is, for example, a resin material or an abrasive grain, but is not particularly limited.

In a case where maximum height Sz and average height Sa have a relationship of “Sz≤Sa x predetermined value” (YES in S23), CPU 51 acquires a signal detected by optical sensor 22 at the time of machining for the machining condition for which the measurement result is used to calculate each of parameters Sz, Sa is acquired (S24).

On the other hand, in a case where the relationship of “Sz≤Sa x predetermined value” is not satisfied, that is, in a case where maximum height Sz is larger than the value obtained by multiplying average height Sa by the predetermined value (NO in S23), CPU 51 proceeds to step S30 without performing the processing of step S24. For example, CPU 51 sets the machining condition for which parameters Sz, Sa have been calculated as a target for remeasurement, or transits the machining condition to be processed to a condition under which machining is performed next to the machining condition under a plurality of preset machining conditions (S30).

For example, CPU 51 determines whether or not there is remeasurement or next machining condition under the plurality of machining conditions (S31), and if there is remeasurement or next machining condition (YES in S31), the processing returns to step S21. CPU 51 acquires the measurement result of the re-measured surface roughness or the measurement result under the next processing condition (S21), and repeats the processing in and after step S22.

According to the above processing, using a predetermined value, according to the relationship between maximum height Sz and average height Sa (S23), a signal under the machining condition under which each of parameters Sz, Sa is calculated is acquired (S24) or remeasurement or the like is performed (S30). In this manner, for example, outlier of the measurement result due to disturbance factors such as foreign matters or the like can be excluded, and training data D1 can be constructed by associating the measurement result under the machining conditions obtained by accurately measuring the surface roughness with the signal detected at the time of machining under the machining conditions.

The predetermined value in step S23 may be experimentally set in consideration of variations of parameters Sz and Sa due to the disturbance factors as described above. In addition, the calculation for determining the relationship between parameters Sz, Sa is not limited to the example of step S23. For example, in addition to the measurement of the surface roughness, when foreign matter, dirt, or the like on the surface is detected by image processing in an image obtained by photographing the surface of workpiece 70 with a camera, step S30 may be executed so as to exclude the measurement result from training data D1. In addition, in a case where the surface roughness is measured again after step S30, the surface roughness in the vicinity of melted portion 27 after welding may be measured, but the surface roughness may be measured in the region to be welded of workpiece 70 and the machining conditions similar to those before the remeasurement, and then welding may be performed again, and the subsequent processing may be executed. The surface roughness in melted portion 27 is considered to be substantially similar to the surface roughness in the vicinity of melted portion 27, and the measurement position of the surface roughness is not particularly limited as long as it is a surface of workpiece 70 irradiated with laser beam 6, but a region before welding in which melted portion 27 is formed is more preferable.

After the signal is acquired (S24), for example, CPU 51 may execute processing of correcting the start time of the signal so as to unify the rise-up start time (that is, the start time) of the signal waveform among a plurality of signals acquired every execution of step S24 (S25). For example, the start time of the signal as illustrated in FIGS. 6 (A) to 6 (C) can be set to the reception time when inspection device 50 receives a trigger signal output at the time of oscillation of laser beam 6 from laser machining device 30. At this time, an error may occur in the start time due to an error in the start time of the trigger signal or the like.

In step S25, CPU 51 performs correction so as to offset the start time of the signal according to the time when the signal intensity reaches a predetermined value (for example, 0.2 V) at the rise-up time of the signal waveform, for example. According to such correction, for example, in processing (S26) of calculating a feature amount to be described later, conditions at the time of calculation can be unified between signals, and training data D1 capable of constructing determination model 57 with higher accuracy can be obtained.

Next, CPU 51 sets time section T2 corresponding to the peak output of the laser output as a predetermined time section in the signal for each machining, for example, and calculates a ratio of a period in which the signal intensity exceeds a predetermined threshold value in time section T2 based on the acquired signal (S26). The predetermined threshold value is set in advance for each component of the reflected light, the heat radiation, and the visible light, for example, based on an average signal waveform, that is, an average waveform, and is stored in storage device 53. The average waveform is calculated as, for example, a waveform obtained by performing laser machining a plurality of times in advance for each machining condition and averaging signal intensities of signals acquired each time. For example, a value obtained by adding the standard deviation of the signal intensity to the average value of the signal intensity in time section T2 of the average waveform is set as the upper limit threshold value, and a value obtained by subtracting the standard deviation is set as the lower limit threshold value.

In step S26, CPU 51 calculates a ratio (also referred to as an “NG ratio”) at which the signal intensity of the acquired signal exceeds the threshold value of the average waveform as described above (that is, it is larger than the upper limit threshold value or smaller than the lower limit threshold value). The NG ratio may be calculated by multiplying a calculation value according to the following calculation formula (1) by “100” to obtain as a percentage. In the following calculation formula (1), the number of sampling points of the corresponding signals may be used as time section T2 and the period exceeding the threshold value.

$$NG ratio = period exceeding threshold value in the time section T 2 / time section T 2 \qquad ( 1 )$$

After calculating the NG ratio of the acquired signal (S26), CPU 51 determines whether or not the calculated NG ratio is less than a predetermined value (for example, 20%) (S27).

If the calculated NG ratio is less than the predetermined value (YES in S27), CPU 51 calculates a feature amount based on the acquired signal (S28). For example, as described above, CPU 51 calculates the average value and the integrated value of the signal intensity in time section T2 as the feature amounts. In step S28, another feature amount may be calculated according to the feature amount used in the inspection processing (FIG. 5).

On the other hand, if the calculated NG ratio is more than or equal to the predetermined value (NO in S27), CPU 51 does not particularly execute the calculation of the feature amount (S28), and proceeds to step S30 similarly to the case where average height Sa and maximum height Sz of the surface roughness do not have a predetermined relationship (NO in S23). For example, CPU 51 sets the machining condition for which the ratio has been calculated as a target for remeasurement, or transits the machining condition to be processed to the next machining condition (S30).

According to the above processing, in accordance with the ratio at which the signal intensity exceeds the threshold value of the average waveform in the predetermined time section (S27), the feature amount is calculated from the signal intensity (S28), or remeasurement or the like is performed (S30). As described above, in the generation of training data D1, for example, while a signal having an abnormal waveform due to the occurrence of disturbance or the like is excluded, a feature amount can be calculated and used from a signal considered to have a relatively small influence of disturbance.

CPU 51 adds, to training data D1, the feature amount calculated in step S28 and the calculated value of the surface roughness, which is calculated from the measurement result under the machining condition under which the feature amount is calculated and in which parameters Sa and Sz have a predetermined relationship in step S23 in association with each other (S29). The calculated value of the surface roughness to be added may be one or both of average height Sa and maximum height Sz according to the inspection result output in the inspection processing (FIG. 5). CPU 51 stores or updates added training data D1 in storage device 53.

When adding the feature amount and the calculated values of the surface roughness to training data D1 (S29), CPU 51 proceeds to the determination of step S31, and if there is the next machining condition in the plurality of machining conditions (YES in S31), the processing of S21 and subsequent processing are repeated for the next machining condition.

On the other hand, if there is no remeasurement or next machining condition (NO in S31), CPU 51 ends the processing of the flowchart.

According to the above processing, for each machining condition, the calculated value calculated from the measurement result of the surface roughness (S21, S22) and the feature amount calculated from the signal such as the reflected light detected at the time of machining (S24, S28) are added to training data D1 in association with each other (S29). Using training data D1 generated by such generation processing, the training processing (FIG. 8) of determination model 57 can be executed. Furthermore, in the generation processing of training data D1 in the present exemplary embodiment, for the acquired surface roughness and signal, exclusion of data having a high possibility of variation due to disturbance or the like (S23, S26 to S27) and correction for unifying start times of signals (S25) are performed as preprocessing. As a result, for example, the quality of data included in training data D1 can be improved.

The threshold value of the average waveform in step S26 may be set based on the signal after the start time is corrected by processing similar to step S25, or may be set based on the average value and the standard deviation of the signals acquired in step S24. In addition, instead of the standard deviation, a value obtained by multiplying the standard deviation by a predetermined ratio may be used. In addition, the calculation period of the ratio exceeding the threshold value in step S26 is not limited to time section T2, and may be set by the user of inspection device 50 via communication circuit 52 or the like, for example.

In addition, it is preferable that the predetermined value in step S27 can be arbitrarily changed by the user, for example, but may be automatically set in inspection device 50. The predetermined value may be set for the laser output, and is preferably set for each of the reflected light, the heat radiation, and the visible light, but may be set to a common value.

### 3. Effects and Others

As described above, the inspection processing (S1 to S4) according to the present exemplary embodiment provides a method of inspecting workpiece 70 in laser machining. The present method includes: a step (S1) of acquiring a signal generated by detecting, with optical sensor 22, at least one of components of heat radiation, visible light, and reflected light generated by irradiation to workpiece 70 with laser beam 6, and indicating a change in the component in time section T1 corresponding to a welding time for each workpiece 70; a step (S2) of calculating a feature amount indicating a feature of the signal in time section T2 (an example of a predetermined section) of time section T1; a step (S3) of determining surface roughness of workpiece 70 by inputting the calculated feature amount to determination model 57 that determines surface roughness indicating a surface property of a surface of workpiece 70 irradiated with laser beam 6; and a step (S4) of outputting the determined surface roughness as an inspection result. Determination model 57 is constructed based on training data D1 including a feature amount calculated from a signal of a component detected by performing laser machining under each condition in a plurality of conditions in which the surface roughness is varied and the surface roughness of each condition in association with each other (see FIGS. 8 and 9).

According to the above method, a signal generated by detecting one or more components of heat radiation, visible light, and reflected light generated by irradiation to workpiece 70 with laser beam 6 is acquired (S1), and a feature amount is calculated based on the signal (S2). Then, a predicted value of the surface roughness is calculated from the feature amount by determination model 57 constructed based on training data D1 (S3). As described above, for example, even if the surface roughness is not directly measured using determination model 57, the surface roughness can be inspected based on the predicted value, and the surface roughness can be easily inspected.

In the present exemplary embodiment, the surface roughness of training data D1 is measured in a region corresponding to a range in which the surface of workpiece 70 is irradiated with laser beam 6 under each condition (similar to the inspection target). For example, in the laser machining of the lap-welding, the surface roughness may be measured for a region where melted portion 27 is formed by welding in the surface of the upper material of workpiece 70 on the side irradiated with laser beam 6.

In the present exemplary embodiment, time section T2 corresponds to a period during which laser beam 6 is irradiated for each workpiece 70 at the peak output (see FIG. 6), and the feature amount includes the average intensity in time section T2 of the signal. As illustrated in FIG. 7, the signal intensity particularly at the time of peak output can change according to the change in surface roughness. Therefore, it is considered that the surface roughness can be accurately predicted by using the average intensity of time section T2 as the feature amount.

In the present exemplary embodiment, the feature amount further includes an integrated value in time section T2 of the signal. As described above with reference to FIG. 7, since the surface roughness can affect the shape of melted portion 27 formed at the time of machining, the amount of light from the surface can be increased or decreased together with the change in the surface temperature of melted portion 27 due to the change in the input heating value by the irradiation of laser beam 6. When the integrated value is used, it is considered that the surface roughness can be accurately predicted by reflecting such a change in the light amount on the feature amount.

In the present exemplary embodiment, the surface roughness includes arithmetic average height Sa and maximum height Sz calculated based on the displacement in the vertical direction from the reference surface (an example of the reference surface on the surface of the workpiece) of workpiece 70. The method further includes a step (S23) of determining whether or not arithmetic average height Sa and maximum height Sz calculated by measuring the surface roughness of workpiece 70 under each condition have a relationship of “maximum height Sz≤arithmetic average height Sa x predetermined value” as an example of a predetermined relationship before determination model 57 is constructed based on training data D1, and a step (YES in S23, S24,S29) of generating training data D1 by selectively including the surface roughness under the condition having the relationship among the plurality of conditions and the feature amount under the condition. As a result, for example, training data D1 can be generated while suppressing the influence of disturbance factors such as variation in the measurement result of the surface roughness when a foreign matter or the like adheres to the surface of workpiece 70. According to such training data D1, highly accurate determination model 57 can be constructed.

The method in the present exemplary embodiment further includes steps of: calculating a ratio of a section in which the intensity of the acquired signal exceeds the threshold value in time section T2 (an example of the predetermined section) by the threshold value (an example of threshold value set for signal intensity of component detected under each condition in a plurality of conditions) of the average waveform before the determination model is constructed based on training data D1 (S26); and generating training data D1 so as to selectively calculate and include the feature amount from a plurality of conditions by comparing the calculated NG ratio with a predetermined value (an example of the predetermined ratio) (S27 to S29). For example, when fluctuation in the signal intensity is provided by various types of disturbance factors, an abnormal signal waveform may occur. According to the above processing, even in such a case, for example, training data D1 can be selectively generated from a plurality of conditions such that the feature amount from the signal is not included in training data D1 as an abnormal signal waveform when the ratio exceeding the threshold value is equal to or more than a predetermined ratio. This also makes it possible to suppress the influence of disturbance factors in training data D1.

In the present exemplary embodiment, determination model 57 is generated by machine learning so as to minimize an error between surface roughness determined based on a feature amount of each condition in the training data D1 and surface roughness of each condition in the training data D1 (S11, S12). As described above, by machine learning using training data D1 in which the feature amount of each condition and the surface roughness measured under the condition are associated with each other, determination model 57 that determines the surface roughness of workpiece 70 is obtained from the feature amount calculated based on the signal detected at the time of machining of workpiece 70.

In the present exemplary embodiment, the surface roughness includes arithmetic average height Sa or Ra and/or maximum height Sz or Rz as an example of a numerical value indicating displacement in the vertical direction from the reference surface on the surface of workpiece 70. The surface roughness determined by determination model 57 is not limited thereto, and may include other surface roughness or line roughness parameters.

In inspection system 100 of the present exemplary embodiment, inspection device 50 is an example of an inspection device for workpiece 70 in laser machining. Inspection device 50 includes, as an example of an arithmetic circuit, CPU 51, and communication circuit 52. Communication circuit 52 receives a signal generated by optical sensor 22 detecting at least one of components of heat radiation, visible light, and reflected light generated by irradiation to workpiece 70 with laser beam 6. The signal is a signal indicating a change in the component in time section Tl as an example of a time section corresponding to the welding time for each workpiece 70. CPU 51 acquires a signal by communication circuit 52 (S1), calculates a feature amount indicating a feature of the signal in time section T2 (an example of a predetermined section) of time section T1 (S2), inputs the calculated feature amount to determination model 57 that determines surface roughness indicating the surface property of the surface of workpiece 70 irradiated with laser beam 6, determines the surface roughness of workpiece 70 (S3), and outputs the determined surface roughness as an inspection result (S4). Determination model 57 is constructed based on training data D1 including a feature amount calculated from a signal of a component detected by performing laser machining under each condition in a plurality of conditions in which the surface roughness is varied and the surface roughness of each condition in association with each other.

According to inspection device 50 described above, it is possible to easily inspect the surface roughness of workpiece 70 by executing the above-described inspection method.

### Other Exemplary Embodiments

As described above, the exemplary embodiment has been described as an example of the art disclosed in the present application. The art according to the present disclosure is, however, not limited to the above exemplary embodiment, and is applicable to other exemplary embodiments suitably made by modification, replacement, addition, or omission, for example. In addition, a different exemplary embodiment can also be made by a combination of the components of the exemplary embodiments described above.

In the first exemplary embodiment described above, an example has been described in which the measurement result of the surface roughness of workpiece 70 and the signal detected at the time of machining are acquired in the generation processing of training data D1 (FIG. 10) (S21, S24). In the present exemplary embodiment, in addition to these, for example, a measurement result of the width, length, and/or area of melted portion 27 in workpiece 70 after welding, and/or a measurement result of penetration depth, or the like may be further acquired. For example, such an additional measurement result may be used as the feature amount of determination model 57 from the viewpoint of utilization for improvement in accuracy in prediction of surface roughness.

In each of the exemplary embodiments described above, an example has been described in which a signal detected at the time of machining under each machining condition is acquired in the generation processing of training data D1 (S24). In the present exemplary embodiment, a plurality of signals detected at the time of each machining may be acquired in step S24 by performing machining a plurality of times under each machining condition. In this case, for example, similarly to step S25, after the start time of each signal is corrected, the subsequent processing may be executed based on the average waveform of the plurality of signals. As a result, for example, in the feature amount calculated from the signal, it is possible to reduce the influence of the fluctuation of the signal waveform due to the disturbance when the light of each signal is detected.

In each of the exemplary embodiments described above, an example has been described in which the NG ratio is calculated as the ratio at which the signal intensity exceeds the threshold value within time section T2 in the generation processing of training data D1 (S26). In the present exemplary embodiment, the time section is not limited to time section T2, and may be calculated, for example, in time section T1 (see FIG. 6) corresponding to one pulse of laser beam 6, or may be calculated in an acquisition period corresponding to one waveform of a signal without particularly providing a section.

In each of the exemplary embodiments described above, an example has been described in which the surface roughness and the signal acquired by inspection device 50 are preprocessed in the generation processing of training data D1 (S23, S25 to S27). Such preprocessing is preferable in generating training data D1 for constructing determination model 57 with higher accuracy, but need not be particularly executed in the present exemplary embodiment, and may be optionally executed by the user.

In each of the exemplary embodiments described above, an example has been described in which the generation processing of training data D1 is executed in inspection device 50. In the present exemplary embodiment, the generation processing of training data D1 is not limited to being executed by inspection device 50, and may be executed by an external information processing device.

In each of the exemplary embodiments described above, an example of lap-welding has been described as laser machining in the present disclosure, but the present disclosure is applicable to determination of surface roughness of a workpiece in various types of welding machining. In addition, the present disclosure may be applied to cutting or drilling with a laser beam as laser machining other than welding. Even in the case of such machining, for example, a determination model of the surface roughness is constructed similarly to each of the exemplary embodiments described above for the surface irradiated with the laser beam during machining in the workpiece, and the surface roughness of the region to be processed can be easily inspected.

The present disclosure is not limited to the exemplary embodiments described above, and various modifications can be made. That is, exemplary embodiments obtained by combining technical means suitably modified by those skilled in the art also fall within the scope of the present disclosure.

### Aspects of The Present Disclosure

As described above, the present disclosure includes the following aspects.

### First Aspect

An inspection method of a workpiece in laser machining, the method includes steps of:
acquiring a signal generated by detecting, with an optical sensor, at least one of components of heat radiation, visible light, and reflected light generated by irradiation to the workpiece with a laser beam, and indicating a change in the component in a time section corresponding to a machining time for each workpiece;
calculating a feature amount indicating a feature of the signal in a predetermined section of the time section;
determining surface roughness of the workpiece by inputting the calculated feature amount to a determination model that determines surface roughness indicating a surface property of a surface of the workpiece irradiated with the laser beam; and
outputting a predicted value of the calculated surface roughness as an inspection result, in which
the determination model is constructed based on training data including a feature amount calculated from a signal of the component detected by performing the laser machining under each condition in a plurality of conditions in which the surface roughness is varied and the surface roughness of each condition in association with each other.

### Second Aspect

The inspection method according to first aspect, in which
surface roughness of the training data is measured in a region corresponding to a range in which a surface of a workpiece is irradiated with a laser beam under each of the conditions.

### Third Aspect

The inspection method according to first aspect or second aspect, in which
the predetermined section corresponds to a period during which a laser beam is irradiated for each workpiece at a peak output, and
the feature amount includes an average intensity of the signal in the predetermined section.

### Fourth Aspect

The inspection method according to any one of first aspect to third aspect, in which
the predetermined section corresponds to a period during which a laser beam is irradiated for each workpiece at a peak output, and
the feature amount includes an integrated value of the signal in the predetermined section.

### Fifth Aspect

The inspection method according to any one of first aspect to fourth aspect, in which
the surface roughness includes an arithmetic average height and a maximum height calculated based on displacement in a vertical direction from a reference surface on a surface of the workpiece, and
the inspection method further includes steps of:
before the determination model is constructed based on the training data,
determining whether or not an arithmetic average height and a maximum height calculated by measurement of surface roughness in the workpiece under each of the conditions have a predetermined relationship; and
generating the training data by selectively including the arithmetic average height and the maximum height calculated as the surface roughness of the conditions having the predetermined relationship among the plurality of conditions and the feature amount under the condition.

### Sixth Aspect

The inspection method according to any one of first aspect to fifth aspect, further including steps of:
before the determination model is constructed based on the training data,
calculating, for a signal of the component detected under each condition in the plurality of conditions, a ratio of a section in which an intensity of the signal exceeds a threshold value in the predetermined section using the threshold value set for the signal intensity; and
generating the training data to selectively calculate and include the feature amount from the plurality of conditions by comparing the calculated ratio with a predetermined ratio.

### Seventh Aspect

The inspection method according to any one of first aspect to sixth aspect, in which

the determination model is generated by machine learning to minimize an error between surface roughness determined from a feature amount of each condition in the training data and surface roughness of each condition in the training data.

### Eighth Aspect

The inspection method according to any one of first aspect to seventh aspect, in which

the surface roughness includes a numerical value indicating displacement in a vertical direction from a reference surface on a surface of the workpiece.

### Ninth Aspect

An inspection device being an inspection device for a workpiece in laser machining, the inspection device including:
an arithmetic circuit; and
a communication circuit configured to receive a signal generated by an optical sensor detecting at least one of components of heat radiation, visible light, and reflected light generated by irradiation to the workpiece with a laser beam, in which
the signal is a signal indicating a change in the component in a time section corresponding to a machining time for each workpiece,
the arithmetic circuit:
acquires the signal by the communication circuit;
calculates a feature amount indicating a feature of the signal in a predetermined section of the time section;
determines surface roughness of the workpiece by inputting the calculated feature amount to a determination model configured to determine surface roughness indicating a surface property of a surface of the workpiece irradiated with the laser beam; and
outputs a predicted value of the calculated surface roughness as an inspection result, and
the determination model is constructed based on training data including a feature amount calculated from a signal of the component detected by performing the laser machining under each condition in a plurality of conditions in which the surface roughness is varied and the surface roughness of each condition in association with each other.

### Tenth Aspect

The inspection device according to ninth aspect, in which
the determination model is generated by machine learning to minimize an error between surface roughness determined from a feature amount of each condition in the training data and surface roughness of each condition in the training data.

### INDUSTRIAL APPLICABILITY

The present disclosure is applicable to a workpiece inspection method and device that determine surface roughness of a surface of a workpiece irradiated with a laser beam in various types of laser machining such as lap-welding.

### REFERENCE MARKS IN THE DRAWINGS

1: laser oscillator
2: laser transmission fiber
3: lens barrel
4: collimating lens
5, 11: condenser lens
6: laser beam
7: first mirror
8: second mirror
13: optical fiber
15: collimating lens
16: third mirror
17: fourth mirror
18: fifth mirror
19, 20, 21: condenser lens
22: optical sensor
23: transmission cable
24: controller
25: optical sensor
26: hold jig
27: melted portion
30: laser machining device
40: spectrometer
50: inspection device
51: CPU
52: communication circuit
53: storage device
56: control program
57: determination model
70: workpiece

D1: training data
100: inspection system

1. An inspection method being a method of inspecting a workpiece in laser machining, the method comprising steps of:
acquiring a signal generated by detecting, with an optical sensor, at least one of components of heat radiation, visible light, and reflected light generated by irradiation to the workpiece with a laser beam, and indicating a change in the component in a time section corresponding to a machining time for each workpiece;
calculating a feature amount indicating a feature of the signal in a predetermined section of the time section;
determining surface roughness of the workpiece by inputting the calculated feature amount to a determination model configured to determine surface roughness indicating a surface property of a surface of the workpiece irradiated with the laser beam; and
outputting a predicted value of the calculated surface roughness as an inspection result, wherein
the determination model is constructed based on training data including a feature amount calculated from a signal of the component detected by performing the laser machining under each condition in a plurality of conditions in which the surface roughness is varied and the surface roughness of each condition in association with each other.

2. The inspection method according to claim 1, wherein
surface roughness of the training data is measured in a region corresponding to a range in which a surface of a workpiece is irradiated with a laser beam under each of the conditions.

3. The inspection method according to claim 1, wherein
the predetermined section corresponds to a period during which a laser beam is irradiated for each workpiece at a peak output, and
the feature amount includes an average intensity of the signal in the predetermined section.

4. The inspection method according to claim 1, wherein
the predetermined section corresponds to a period during which a laser beam is irradiated for each workpiece at a peak output, and
the feature amount includes an integrated value of the signal in the predetermined section.

5. The inspection method according to claim 1, wherein
the surface roughness includes an arithmetic average height and a maximum height calculated based on displacement in a vertical direction from a reference surface on a surface of the workpiece,
the inspection method further comprising steps of:
before the determination model is constructed based on the training data,
determining whether or not an arithmetic average height and a maximum height calculated by measurement of surface roughness in the workpiece under each of the conditions have a predetermined relationship; and
generating the training data by selectively including the arithmetic average height and the maximum height calculated as the surface roughness of the conditions having the predetermined relationship among the plurality of conditions and the feature amount under the condition.

6. The inspection method according to claim 1, further comprising steps of:
before the determination model is constructed based on the training data,
calculating, for a signal of the component detected under each condition in the plurality of conditions, a ratio of a section in which the intensity of the signal exceeds a threshold value in the predetermined section using the threshold value set for the signal intensity; and
generating the training data to selectively calculate and include the feature amount from the plurality of conditions by comparing the calculated ratio with a predetermined ratio.

7. The inspection method according to claim 1, wherein
the determination model is generated by machine learning to minimize an error between surface roughness determined from a feature amount of each condition in the training data and surface roughness of each condition in the training data.

8. The inspection method according to claim 1, wherein
the surface roughness includes a numerical value indicating displacement in a vertical direction from a reference surface on a surface of the workpiece.

9. An inspection device being an inspection device for a workpiece in laser machining, the inspection device comprising:
an arithmetic circuit; and
a communication circuit configured to receive a signal generated by an optical sensor detecting at least one of components of heat radiation, visible light, and reflected light generated by irradiation to the workpiece with a laser beam, wherein
the signal is a signal indicating a change in the component in a time section corresponding to a machining time for each workpiece,
the arithmetic circuit
acquires the signal by the communication circuit;
calculates a feature amount indicating a feature of the signal in a predetermined section of the time section;
determines surface roughness of the workpiece by inputting the calculated feature amount to a determination model configured to determine surface roughness indicating a surface property of a surface of the workpiece irradiated with the laser beam; and
outputs a predicted value of the calculated surface roughness as an inspection result, and
the determination model is constructed based on training data including a feature amount calculated from a signal of the component detected by performing the laser machining under each condition in a plurality of conditions in which the surface roughness is varied and the surface roughness of each condition in association with each other.

10. The inspection device according to claim 9, wherein
the determination model is generated by machine learning to minimize an error between surface roughness determined from a feature amount of each condition in the training data and surface roughness of each condition in the training data.
